(19) United States
(12) Patent Application Publication
(10) Pub. No.: US 2025/0283664 A1
(43) Pub. Date: Sep. 11, 2025

(54) ROTARY SINTERING FURNACE

(71) Applicants: TINCI MATERIALS (TAIZHOU) CO., LTD., Taizhou (CN); GUANGZHOU TINCI MATERIALS TECHNOLOGY CO., LTD., Guangzhou (CN)

(72) Inventors: Dazhong GUO, Taizhou (CN); Jinyong WU, Taizhou (CN); Minhua LIAO, Taizhou (CN); Litao SHI, Taizhou (CN)

(21) Appl. No.: 19/216,768

(22) Filed: May 23, 2025

Related U.S. Application Data
(63) Continuation of application No. PCT/CN2024/100354, filed on Jun. 20, 2024.

(30) Foreign Application Priority Data
Apr. 29, 2024 (CN) 202410531974.6
Apr. 29, 2024 (CN) 202420926866.4

(51) Int. Cl. F27D 25/00; F27B 7/20

(52) U.S. Cl. CPC F27D 25/001; F27B 7/20; F27M 2003/04

(57) ABSTRACT

Provided is a rotary sintering furnace. The rotary sintering furnace includes a furnace body assembly and a knocking device. The furnace body assembly includes a rotary furnace and a heat preservation housing. The rotary furnace is rotatably disposed through the heat preservation housing, and the heat preservation housing has a via hole. The knocking device is disposed outside the heat preservation housing. The knocking device includes a knocking member. The knocking is configured to movably pass through the via hole and knock on the rotary furnace.

### CROSS-REFERENCE TO RELATED APPLICATIONS

The present application is a continuation of International Application No. PCT/CN2024/100354, filed on Jun. 20, 2024, which claims the priority of the Chinese patent application No. 202410531974.6 and Chinese patent application No. 202420926866.4, filed on Apr. 29, 2024. The disclosures of the aforementioned applications are hereby incorporated by reference in their entireties.

### FIELD

The present disclosure relates to the field of rotary sintering furnaces, and more particularly, to a rotary sintering furnace.

### BACKGROUND

A rotary sintering furnace is a thermal apparatus for calcining, roasting, or drying granular and powdery materials. The rotary sintering furnace has advantages such as systematic combustion, strong technical power, accurate gas distribution, and low burn loss rate, and thus it may be used for drying, dehydration, and roasting of materials in a chemical industry. For example, the rotary sintering furnace may be used in production and manufacture of lithium iron phosphate in the new energy field. The rotary sintering furnace used for the production and manufacture of lithium iron phosphate may be an electrothermal continuous production device. Before normal operation, the rotary sintering furnace is first heated. When a temperature of the rotary furnace rises to a temperature required by the process, a material to be roasted is fed into the rotary furnace through a material guide pipe of a feed box of a furnace head. The material is indirectly heated through the rotary furnace to achieve a purpose of roasting. The rotary furnace has spiral blades provided therein, which rotate at a slow speed with the rotary furnace synchronously. The material is roasted in the rotary furnace and transported to an end of the furnace through the spiral blade simultaneously. Finally, the material is fed into a next equipment through a discharge box at the end of the furnace. When the rotary sintering furnace is used for manufacturing lithium iron phosphate, problems such as the occurrence of bonded cladding material and the high impurity content in a lithium-iron-phosphate positive electrode material.

### SUMMARY

The present disclosure provides a rotary sintering furnace. The rotary sintering furnace includes: a furnace body assembly and a knocking device. The furnace body includes a rotary furnace and a heat preservation housing. The rotary furnace is rotatably disposed through the heat preservation housing, and the heat preservation housing has a via hole. The knocking device is disposed outside the heat preservation housing. The knocking device includes a knocking member. The knocking member is configured to movably pass through the via hole and knock on the rotary furnace.

### BRIEF DESCRIPTION OF THE DRAWINGS

The above and/or additional aspects and advantages of the present disclosure will become more apparent and more understandable from the following description of embodiments taken in conjunction with the accompanying drawings, in which:

FIG. 1 is a main view of a rotary sintering furnace according to an embodiment of the present disclosure.

FIG. 2 is a top view of a rotary sintering furnace according to an embodiment of the present disclosure.

FIG. 3 is a schematic structural view of a support according to a first embodiment of the present disclosure.

FIG. 4 is a schematic structural view of a knocking device according to a first embodiment of the present disclosure.

FIG. 5 is a schematic structural view of a part of a knocking device according to a first embodiment of the present disclosure.

FIG. 6 is a partially enlarged view of a rotary sintering furnace according to a second embodiment of the present disclosure.

FIG. 7 is a partially schematic structural view of a rotary sintering furnace according to a second embodiment of the present disclosure.

### REFERENCE NUMERALS

rotary sintering furnace 1000;
furnace body assembly 100; temperature rise section 101; temperature holding section 102;
cooling section 103;
rotary furnace 1; furnace head 11; heat preservation housing 5;
knocking device 200;
driving member 6; driving end 61;
knocking member 7; knocking section 71; connection section 72; weighted weight 73;
guide wheel 81; pull rope 82;
support 9; vertical frame 91; top frame 92; bottom frame 93; guide cylinder 94; guide hole 95;
pneumatic knocking hammer 400.

### DETAILED DESCRIPTION

The present disclosure aims to at least solve one of the technical problems existing in the prior art. To this end, an objective of the present disclosure is to provide a rotary sintering furnace. The rotary sintering furnace is beneficial to a reduction in bonding of cladding materials in discharging materials and a reduction in an impurity content in the discharging materials.

The rotary sintering furnace according to the embodiments of the present disclosure includes: a furnace body assembly and a knocking device. The furnace body includes a rotary furnace and a heat preservation housing. The rotary furnace is rotatably disposed through the heat preservation housing, and the heat preservation housing has a via hole. The knocking device is disposed outside the heat preservation housing. The knocking device includes a knocking member. The knocking member is configured to movably pass through the via hole and knock on the rotary furnace.

With the rotary sintering furnace according to embodiments of the present disclosure, the knocking member can knock on the rotary sintering furnace at any time before or after the sintering process, or during the sintering process, which is conducive to timely knocking off the material bonded to the rotary furnace, thereby alleviating temperature uniformity of an inner wall of the rotary furnace and reducing the possibility of the material reacting with a furnace wall material. Thus, the problem that the product carries impurities or has the over-sintered material can be avoided, thereby improving the product quality. Moreover, no manual assistance and manual cleaning are required during cleaning, and a cost of manual cleaning is lowered.

In addition, the rotary sintering furnace according to the above embodiments of the present disclosure may also have the following additional technical features.

According to some embodiments of the present disclosure, the knocking device further includes a support and a driving member. The support is mounted at the heat preservation housing. The driving member is located outside the heat preservation housing and mounted at the support. The knocking member is connected to the driving member. The knocking member is adapted to reciprocate under the drive of the driving member and to pass through the via hole to knock on the rotary furnace, or the knocking member is adapted to reciprocate under the effect of gravity and the drive of the driving member and to pass through the via hole to knock on the rotary furnace.

According to some embodiments of the present disclosure, the support is provided with a guide wheel; the driving member is connected to the knocking member through a pull rope; the pull rope is wound around the guide wheel; a part of the pull rope located between the guide wheel and the knocking member extends in a vertical direction; and a part of the pull rope located between the guide wheel and the driving member extends in a driving direction of the driving member, the driving direction of the driving member being inconsistent with a movement direction of the knocking member.

According to some embodiments of the present disclosure, at least two guide wheels are provided, and the at least two guide wheels are respectively a first guide wheel and a second guide wheel that are spaced apart from each other, the second guide wheel being position-adjustable in an axial direction of the rotary furnace; the pull rope has an end connected to the driving member and another end connected to the knocking member; and the pull rope is sequentially wound around the first guide wheel and the second guide wheel to connect to the knocking member.

According to some embodiments of the present disclosure, the support has a plurality of guide holes opposite to the via hole. The plurality of guide holes are arranged at intervals in the axial direction of the rotary furnace, and the knocking member selectively passes through one of the plurality of guide holes.

According to some embodiments of the present disclosure, the support has a plurality of mounting positions arranged at intervals in the axial direction of the rotary furnace. The plurality of mounting positions positionally corresponding to the plurality of guide holes, and the second guide wheel being selectively mounted at one of the plurality of mounting positions.

According to some embodiments of the present disclosure, the support has a guide hole opposite to the via hole, and the knocking member is configured to movably pass through the guide hole.

According to some embodiments of the present disclosure, the support includes a top frame, a vertical frame, and a bottom frame. The top frame is connected to the bottom frame through the vertical frame, and the support is mounted at a top of the heat preservation housing through the bottom frame; and a guide wheel is disposed at the top frame. The bottom frame is provided with a guide cylinder. The guide cylinder defines the guide hole, and the driving member is mounted at the vertical frame.

According to some embodiments of the present disclosure, a length of the knocking member is greater than a spacing between an axial outer end of the via hole and an outer circumferential surface of the rotary furnace.

According to some embodiments of the present disclosure, the knocking member includes a knocking section and a plurality of connection sections. The knocking section and the plurality of connection sections are sequentially connected to each other in the movement direction of the knocking member. An end portion of the knocking section is knocked on the rotary furnace. The plurality of connection sections are connected to the driving member. A cross-sectional area of the knocking section perpendicular to the movement direction of the knocking member is greater than a cross-sectional area of each of the plurality of connection sections perpendicular to the movement direction of the knocking member. The cross-sectional area of the knocking section perpendicular to the movement direction of the knocking member is smaller than a cross-sectional area of the guide hole perpendicular to a passing-through direction of the guide hole. The cross-sectional area of the knocking section perpendicular to the movement direction of the knocking member is smaller than a cross-sectional area of the via hole perpendicular to a passing-through direction of the via hole.

According to some embodiments of the present disclosure, the knocking member is provided with a weighted weight.

According to some embodiments of the present disclosure, the weighted weight is mounted and sleeved on the knocking member, and located at a side of the guide hole facing away from the via hole; and a distance L1 between a bottom of the weighted weight and an end portion of the knocking section and a distance L2 between an axial outer end of the guide hole and an outer circumferential surface of the rotary furnace satisfy L1≥L2.

According to some embodiments of the present disclosure, the support is provided with a guide cylinder. The guide cylinder defines the guide hole.

According to some embodiments of the present disclosure, the driving member has a driving end connected to the pull rope; the driving end is movable; one guide wheel is provided; a part of the pull rope located between the guide wheel and the driving end extends parallel to a movement direction of the driving end; and the part of the pull rope located between the guide wheel and the knocking member extends parallel to a passing-through direction of the via hole.

According to some embodiments of the present disclosure, the rotary furnace has a gasket provided at an outer circumferential surface of the rotary furnace. The gasket includes a plurality of cushion blocks arranged at a predetermined distance in a circumferential direction of the rotary furnace. The knocking member acts on the rotary furnace by knocking the plurality of cushion blocks.

According to some embodiments of the present disclosure, the plurality of cushion blocks are made of a same material as the rotary furnace.

According to some embodiments of the present disclosure, a plurality of knocking devices are provided. The plurality of knocking devices are mounted at the heat preservation housing at intervals in an axial direction of the rotary furnace.

According to some embodiments of the present disclosure, a furnace chamber wall of the rotary furnace has a polishing degree Ra smaller than or equal to 3 μm.

According to some embodiments of the present disclosure, the rotary furnace is made of stainless steel or alloy.

According to some embodiments of the present disclosure, the rotary sintering furnace is for use in the preparation of a new energy material by performing dynamic sintering on a raw material, where the new energy material includes a lithium-ion battery positive electrode material, the lithium-ion battery positive electrode material including lithium iron phosphate, lithium cobalt oxide, or lithium nickel cobalt manganate.

Additional aspects and advantages of the present disclosure will be provided in part in the following description, or will become apparent in part from the following description, or can be learned from practicing of the present disclosure.

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the present disclosure.

In the description of the embodiments of the present disclosure, it should be understood that terms such as “center”, “longitudinal”, “lateral”, “length”, “width”, “thickness”, “over”, “below”, “front”, “back”, “left”, “right”, “vertical”, “horizontal”, “top”, “bottom”, “in”, “out”, “clockwise”, “anti-clockwise”, “axial”, “radial” and “circumference” are based on the orientation or position relationship illustrated in the drawings. These terms are only for the convenience of describing the present disclosure and simplifying the description, rather than indicating or implying that the described device or element must have a specific orientation or must be constructed and operated in a specific orientation. Therefore, they cannot be understood as limitations of the present disclosure.

In the description of the present disclosure, “the first feature” and “the second feature” may include at least one of the features, and “plurality” means at least two. The first feature being “on” or “under” the second feature may include the scenarios that the first feature is in direct contact with the second feature, or the first and second features, instead of being in direct contact with each other, are in contact with each other through another feature therebetween. The first feature being “above” the second feature may indicate that the first feature is directly above or obliquely above the second feature, or simply indicate that the level of the first feature is higher than that of the second feature.

A rotary sintering furnace is a thermal apparatus for calcining, roasting, or drying granular and powdery materials. The rotary sintering furnace has advantages such as systematic combustion, strong technical power, accurate gas distribution, and low burn loss rate. However, when the rotary sintering furnace is used for manufacturing lithium iron phosphate, bonded cladding may be found in a lithium-iron-phosphate positive electrode material, with an overhigh impurity content and poor quality. Through research, the present disclosure creatively finds the following facts. During sintering of a lithium iron phosphate material in the rotary sintering furnace, due to characteristics of lithium iron phosphate material itself, the material is likely to be bonded at an inner wall of the rotary furnace or on the spiral blade in the rotary furnace, thereby affecting temperature uniformity of the inner wall of the rotary furnace and causing an excessively high local temperature. The rotary furnace has partially an excessively high temperature due to the bonded material. Thus, the material is likely to react with a material of the furnace wall of the rotary furnace, such that the obtained product carries impurities or have over-sintered material, affecting the quality of the product. Moreover, when the material bonded on the inner wall is sintered at a high temperature for a long period, the material is likely to form an over-sintered cladding. That is, after the material is bonded on the inner wall of the rotary furnace, flake-like solid may be formed by sintering or over-sintered, with a size greater than a required particle size of the material, thereby affecting electric performances of the product, for example, charge-discharge cycling performance. The solid cannot be used for normal purpose after recovery, resulting in waste and an increase in the production costs. At present, the inner wall of the rotary furnace is usually cleaned manually. However, it is inconvenient for an operator to access the interior of the rotary furnace for cleaning, and the cleaning is such troublesome and dangerous that it has to be performed after the sintering. In this case, the bonded materials are more and thicker, making the cleaning process more difficult and resulting in poor cleaning effectiveness.

To this end, the present disclosure provides a rotary sintering furnace 1000. When the rotary sintering furnace 1000 according to the embodiments of the present disclosure is used for manufacturing lithium iron phosphate, the bonded cladding material in the lithium-iron-phosphate positive electrode material can be reduced, and thus the impurity content is lowered and the product quality can be improved.

The rotary sintering furnace 1000 according to the embodiments of the present disclosure is described below with reference to the accompanying drawings.

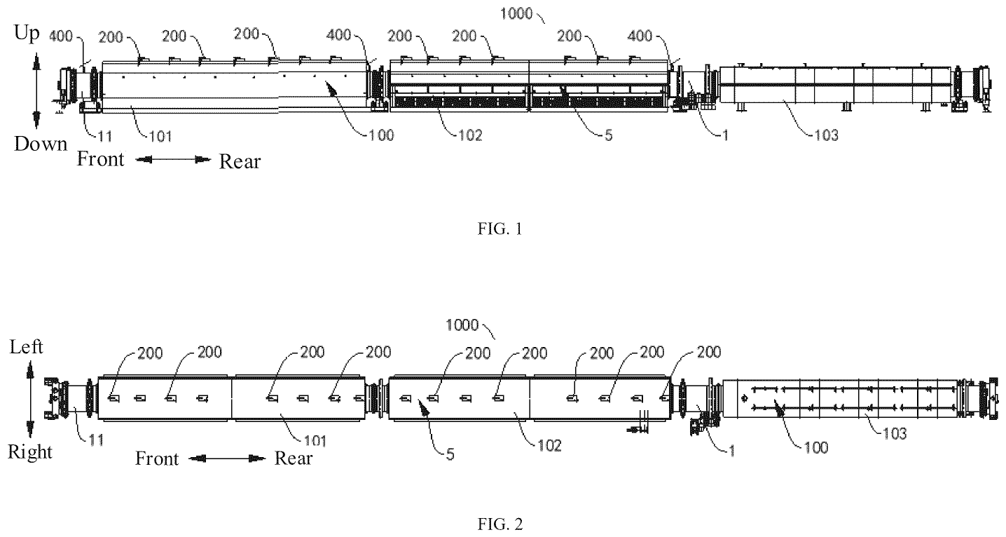

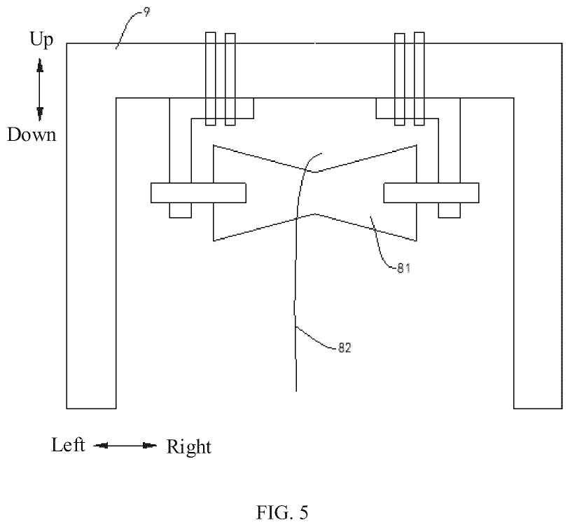

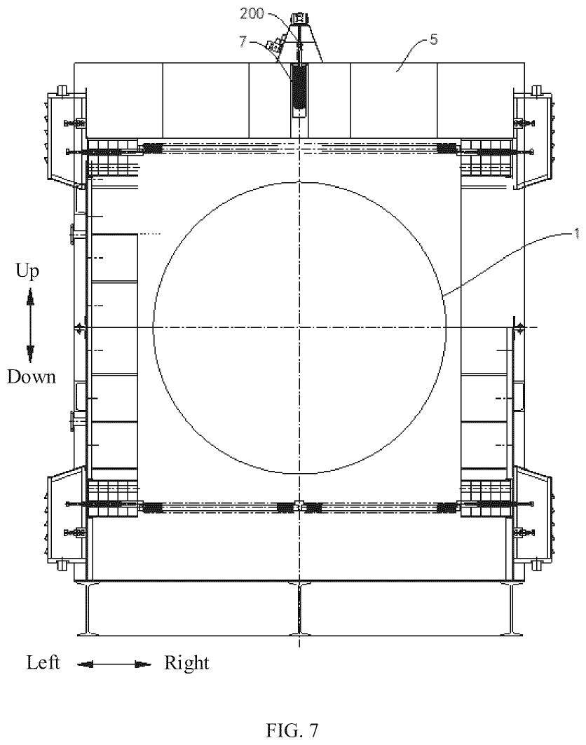

Referring to FIG. 1 to FIG. 7, the rotary sintering furnace 1000 according to the embodiments of the present disclosure may include a furnace body assembly 100 and a knocking device 200.

In some embodiments, the furnace body assembly 100 includes a rotary furnace 1 and a heat preservation housing 5. The rotary furnace 1 is rotatably disposed through the heat preservation housing 5. The heat preservation housing 5 has a via hole. The knocking device 200 is disposed outside the heat preservation housing 5, and the knocking device 200 includes a knocking member 7. The knocking member 7 is configured to movably pass through the via hole and to knock on the rotary furnace 1.

The rotary furnace 1 is used for performing operations such as calcining, roasting, or drying on a material therein. For example, in some embodiments, as illustrated in FIG. 1 and FIG. 2, the rotary furnace 1 is an integrally cylindrical structure. However, the rotary furnace 1 is not required to be an entire cylinder body, for example, it may be composed of a plurality of sections of cylinders rigidly connected to each other. Two ends of the rotary furnace 1 are connected to a feed box and a discharge box, respectively. The rotary furnace 1 has a spiral blade provided therein. The furnace body assembly 100 further includes a heating device and a driving device. The heating device is configured to heat the rotary furnace 1. The driving device is configured to drive the rotary furnace 1 to rotate. The material is transferred into the rotary furnace 1 from the feed box. The rotary furnace 1 is heated by the heating device, to heat the material in the rotary furnace 1. The rotary furnace 1 is driven by the driving device to rotate, while the spiral blade rotates synchronously with the rotary furnace 1. The material in the rotary furnace 1 is pushed to move in a discharge direction with the rotation of the spiral blade during the rotation of the rotary furnace 1 and discharged to the discharge box, thereby performing the operations such as calcination, roasting, or drying on the material in the rotary furnace 1.

The heat preservation housing 5 is used for heat preservation of the internal rotary furnace 1 to reduce a heat loss, which is beneficial to ensuring a high-heat environment of the rotary furnace 1 and an improvement in sintering efficiency. For example, in some embodiments, the furnace body assembly 100 includes a plurality of heating devices. The heating device includes a plurality of electric heaters arranged side by side in an axial direction of the heating device. The electric heaters are disposed between the heat preservation housing 5 and the rotary furnace 1 to heat the rotary furnace 1. The heat loss can be effectively reduced by means of the heat preservation housing 5. Thus, the heat can be sufficiently used for heating the rotary furnace 1, thereby enhancing the heat utilization rate and reducing the sintering cost. It should be understood that the heat preservation housing 5 is not limited in terms of the composition thereof. For example, the heat preservation housing 5 may include a metal housing and a heat preservation layer formed on an inner wall of the metal housing, such as a heat preservation brick and heat preservation cotton. In this way, the heat is effectively locked in the heat preservation housing 5, and a heat waste is lowered.

The heat preservation housing 5 has a via hole, and thus the knocking member 7 can contact and knock on the rotary furnace 1 by passing through the via hole, thereby knocking off the material bonded on the inner wall of the rotary furnace 1. In some embodiments, a lubricating grease or heat preservation cotton is provided at the via hole for dynamic sealing between the via hole and the knocking member 7, which can reduce the heat loss and improve heat preservation performance of the heat preservation housing 5. The knocking member 7 may be in a shape of a hammer, a column, or the like.

The knocking device 200 is disposed outside the heat preservation housing 5, and the heat preservation housing 5 is disposed outside the rotary furnace 1, enabling the knocking member 7 to be disposed outside the rotary furnace 1. In this way, the knocking member 7 is not in direct contact with the material in the rotary furnace 1 during knocking process, to avoid interference of the knocking device 200 on the material transportation and heating. Therefore, a sintering operation of the material in the rotary furnace 1 can be performed smoothly. Moreover, a temperature in the rotary furnace 1 does not affect an operation of the knocking device 200, and operation stability of the knocking device 200 can be improved. In addition, the heat preservation housing 5 and the rotary furnace 1 are independent of each other, facilitating the mounting of the knocking device 200. Therefore, the knocking device 200 can be disassembled or replaced at any time according to actual situations.

After the sintering process, many materials may be bonded to the inner wall of the rotary furnace 1 with a great thickness. Moreover, a cleaning process of the knocking member 7 knocking on the rotary furnace 1 may be performed synchronously with a sintering process, rather than performing after the sintering process. In this way, the materials bonded to the inner wall of the rotary furnace 1 can be timely and easily cleaned before it grows thicker with a lower difficulty, thereby improving the cleaning effect. In other words, the materials bonded to the inner wall of the rotary furnace 1 during the sintering process are less than those after the sintering process and are thus easy to be knocked off, with a lower cleaning difficulty and a high cleaning effect.

In addition, manual assistance is not required during cleaning, which is conducive to the reduction of the cost of manual cleaning and simplifying the cleaning of the material bonded on the inner wall of the rotary furnace 1.

It is worth noting that the bonded material may be mixed into the material in the rotary furnace 1 after being knocked off, and is sieved synchronously after discharging. Those that satisfy a particle size requirement is taken as products for normal use. By knocking off the bonded material in time through the knocking member 7 during the sintering process, the over-sintered cladding can be reduced, thereby reducing the waste, lowering the production cost, and improving the product quality.

In the rotary sintering furnace 1000 according to the embodiments of the present disclosure, by knocking on the rotary furnace 1 by means of the knocking member 7 at any time before and after the sintering process or during the sintering process, the material bonded to the rotary furnace can be advantageously and timely knocked off, thereby improving the temperature uniformity of the inner wall of the rotary furnace 1 and lowering the possibility that the material reacts with a furnace wall material. In this way, the problems of the product carrying the impurities or the occurrence of the over-sintered material in the product, and thus the product quality can be improved. Moreover, no manual assistance and manual cleaning are required during cleaning, and thus the cost of manual cleaning is lowered.

In some embodiments of the present disclosure, the rotary sintering furnace 1000 is applied to the preparation of a new energy material and configured to perform dynamic sintering on a raw material. The new energy material includes a lithium-ion battery positive electrode material. The lithium-ion battery positive electrode material includes lithium iron phosphate, lithium cobalt oxide, or lithium nickel cobalt manganate. The lithium-ion battery positive electrode material includes one of lithium iron phosphate, lithium cobalt oxide, and lithium nickel cobalt manganese oxide. The new energy material such as the lithium-ion battery positive electrode material is prone to bonding or even form over-sintered cladding during the sintering process. By employing the rotary sintering furnace 1000 of the present disclosure for performing sintering on the lithium-ion battery positive electrode material, the bonded material can be timely knocked off. A bonding rate of the lithium-ion battery positive electrode material during the sintering process and a possibility of forming the over-sintered cladding can be lowered, which is beneficial to full sintering of the raw material, a reduction in a waste of the raw material, and the improvement of product quality.

In some embodiments of the present disclosure, as illustrated in FIG. 1 to FIG. 4, the knocking device 200 further includes a driving member 6. The knocking member 7 is connected to the driving member 6. The knocking member 7 is able to reciprocate under the driving of the driving member 6 and to pass through the via hole to knock on the rotary furnace 1.

The driving member 6 may be mounted at the heat preservation housing 5 or at other components, as long as the driving member 6 is able to drive the movement of the knocking member 7. For example, the knocking device 200 further includes a support 9. The support 9 is mounted at the heat preservation housing 5. The driving member 6 is located outside the heat preservation housing 5 and mounted at the support 9.

The knocking member 7 is driven by the driving member 6 to reciprocate, enabling the knocking member 7 to pass through the via hole to knock on the rotary furnace 1 and thus knock off the material bonded on the inner wall of the rotary furnace 1. The knocking member 7 may be disposed horizontally. That is, the knocking member 7 is located at a centrally horizontal plane of the rotary furnace 1 (i.e., a horizontal plane where a rotation axis of the rotary furnace 1 is located). The knocking member 7 can be driven by the driving member 6 to move close to the rotary furnace 1 in a horizontal direction to knock on the rotary furnace 1. The knocking member 7 can also be driven by the driving member 6 to move away from the rotary furnace 1 in the horizontal direction, thereby achieving the reciprocation movement of the knocking member 7. In this way, the knocking member 7 can knock on the rotary furnace 1 repeatedly, thereby improving cleaning efficiency.

In some embodiments, as illustrated in FIG. 1 to FIG. 4, the knocking member 7 is able to reciprocate under action of gravity and the driving of the driving member 6 and to pass through the via hole to knock on the rotary furnace 1, to knock off the material bonded on the inner wall of the rotary furnace 1. The gravity refers to a gravitational action of the knocking member 7 itself. The knocking member 7 can be disposed vertically or obliquely, i.e., the knocking member 7 may be located at a centrally vertical surface of the rotary furnace 1 (i.e., the horizontal plane where the rotation axis of the rotary furnace 1 is located). The knocking member 7 may also be located at a side of the centrally vertical surface of the rotary furnace 1 or at a side of the centrally horizontal plane of the rotary furnace 1. For example, the knocking member 7 is located directly above, directly below, obliquely above, and obliquely below the rotary furnace 1, which is beneficial to a flexible arrangement of relative position of the knocking member 7 and the rotary furnace 1.

For example, in some embodiments, as illustrated in FIG. 1, the knocking member 7 is disposed directly above the rotary furnace 1, enabling the knocking member 7 to be naturally dropped under the action of gravity, i.e., the knocking member 7 is able to move downwards to approach and knock on the rotary furnace 1, which can knock off the material bonded on the inner wall of the rotary furnace 1 more effectively. The knocking member 7 is able to move upwards under the driving of the driving member 6 against the gravity to move away from the rotary furnace 1, and move downwards under the action of gravity to knock on the rotary furnace 1, realizing the reciprocation movement of the knocking member 7. In this way, the knocking member 7 can knock on the rotary furnace 1 repeatedly.

For example, in some embodiments, the knocking member 7 is disposed directly below the rotary furnace 1, enabling the knocking member 7 to be naturally dropped under the action of gravity, i.e., the knocking member 7 is able to move downwards away from the rotary furnace 1, and may be driven by the driving member 6 to move upwards against gravity to approach and knock on the rotary furnace 1, realizing the reciprocation movement of the knocking member 7. In this way, the knocking member 7 can knock on the rotary furnace 1 repeatedly.

For example, in some embodiments, the knocking member 7 is disposed obliquely above the rotary furnace 1, enabling the knocking member 7 to move obliquely downwards and approach the rotary furnace 1 under the action of gravity and the driving of the driving member 6 to knock on the rotary furnace 1, thereby knocking off the material bonded on the inner wall of the rotary furnace 1. Moreover, the knocking member 7 is able to move obliquely upwards and away from the rotary furnace 1 under the driving action of the driving member 6 against the gravity, realizing the reciprocation movement of the knocking member 7. In this way, the knocking member 7 can knock on the rotary furnace 1 repeatedly.

As an example, in the present disclosure, the knocking member 7 is disposed directly above the rotary furnace 1 for illustration. In the rotary sintering furnace 1000 according to the embodiments of the present disclosure, by defining the via hole on the heat preservation housing 5 and providing the knocking device 200 outside the heat preservation housing 5, the knocking member 7 is driven by the driving member 6 against the gravity, and then passes through the via hole under the action of gravity of the knocking member 7, to knock on the rotary furnace 1 located in the heat preservation housing 5, which can overcome an influence of a high temperature environment within the heat preservation housing 5 on the knocking device 200. In this way, each position of the rotary furnace 1 where material bonding may occur can be knocked, and the over-sintering caused by the occurrence of material bonding in the rotary furnace 1 can be avoided.

By means of the gravity, the knocking member 7 can easily perform knocking operation on the rotary furnace 1, and the number of other parts for driving the movement of the knocking member 7 towards the rotary furnace 1 can be reduced, which is beneficial to simplification of the structure. Moreover, by knocking on the rotary furnace 1 through the knocking member 7 entering the interior of the heat preservation housing 5, the area of the via hole can be advantageously reduced, and thus the heat loss in the interior of the heat preservation housing 5 can also be reduced. Compared with a mechanical structure for physical knocking purely by means of the gravity, the rotary sintering furnace 1000 according to the embodiments of the present disclosure can control the time, frequency, and strength of knocking on the rotary furnace 1 by controlling an operation time and operation frequency of the driving member 6, a distance from which the knocking member 7 is driven to move, and the like, which is conducive to the improvement of controllability of the device. Further, the knocking of the knocking member 7 can be adjusted according to an actual sintering process, an internal material bonding condition, a material of the rotary furnace 1, and the like, to avoid the occurrence of local deformation or even damage to the rotary furnace 1 caused by an excessive knocking strength, too high knocking frequency, and long-term fixed knocking position while ensuring a cleaning effect of knocking.

The knocking member 7 may be driven by the driving member 6 against the action of gravity and move away from the rotary furnace 1, so that the knocking member 7 is separated from the rotary furnace 1. After the driving member 6 stops acting, the knocking member 7 is affected by gravity and moves towards the rotary furnace 1. The knocking member 7 knocks on the rotary furnace 1. The reciprocation movement of the knocking member 7 is realized to repeat knocking, and too long contact time of the knocking member 7 with the rotary furnace 1 may be prevented from affecting rotation of the rotary furnace 1 and causing damage such as scratches, crushes, and even deformation to the rotary furnace 1. It is beneficial to knocking and cleaning of the material bonded on the inner wall of the rotary furnace 1 under the premise of protecting the rotary furnace 1.

In addition, a distance between the knocking member 7 and the rotary furnace 1 can be increased through the driving member 6, to ensure a movement range between the knocking member 7 and the rotary furnace 1, enabling the knocking member 7 to move towards the rotary furnace 1 to knock on the rotary furnace 1. Moreover, the distance between the knocking member 7 and the rotary furnace 1 is adjustable by the driving member 6, i.e., a range of a movement of the knocking member 7 towards the rotary furnace 1 can be adjusted, which is conducive to the control of a knocking strength of the knocking member 7 on the rotary furnace 1, avoiding the knocking strength to be excessively great, thereby protecting the rotary furnace 1 from being damaged, and also avoiding the knocking strength to be excessively small, thereby increasing the possibility that the bonded material falls off and advantageously improve the cleaning effect.

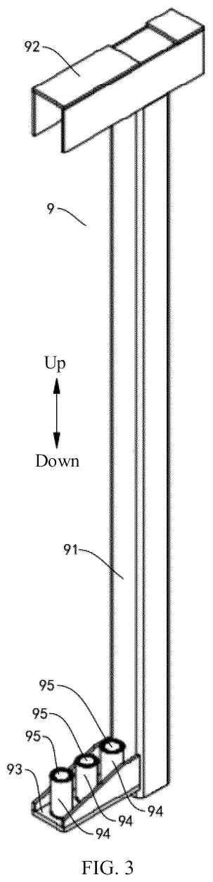

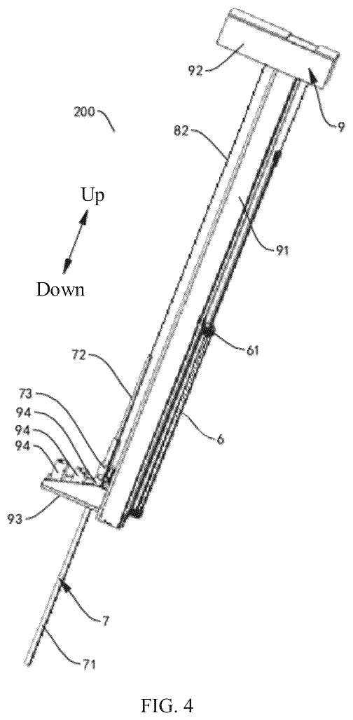

For example, in some embodiments, as illustrated in FIG. 1, FIG. 3, and FIG. 4, the knocking member 7 is disposed directly above the rotary furnace 1, and thus the knocking member 7 can naturally fall under the action of gravity. Through the driving member 6, the knocking member 7 is able to move upwards against the action of gravity, to move away from the rotary furnace 1, enabling the knocking member 7 to move upwards in a vertical direction away from the rotary furnace 1. A height at which the knocking member 7 is driven by the driving member 6 to move upwards may range from 500 mm to 600 mm. For example, the height is 500 mm, 550 mm, 600 mm, or the like.

A knocking frequency of the knocking member 7 to the rotary furnace 1 is also controllable by the driving member 6. For example, the knocking member 7 is caused to knock on the rotary furnace 1 at a predetermined time interval or at irregular time intervals during the rotation of the rotary furnace 1. In this way, the knocking member 7 can advantageously knock on the rotary furnace 1 in more regions along a circumferential direction of the rotary furnace 1, thereby broadening the range of knocking and enhancing the cleaning efficiency.

For example, in some embodiments, the knocking frequency of the knocking member 7 is controlled by the driving member 6 to range from 1 knock/4 s to 1 knock/4 minutes. Thus, the bonded material in the rotary furnace 1 can be timely knocked off, while the rotary furnace 1 can be protected from being damaged due to the high knocking frequency. For example, the knocking is performed once every 4 seconds, every 2 minutes, every 4 minutes, or the like.

Therefore, the knocking member 7 can move towards or away from the rotary furnace 1, which is beneficial to achieving repeated knocking on the rotary furnace 1 by the knocking member 7. Moreover, the frequency and knocking strength of the repeated knockings of the knocking member 7 are controllable by the driving member 6, which is beneficial to cleaning of the bonding material as much as possible while protecting the rotary furnace 1, thereby improving the cleaning efficiency.

In the knocking device 200, the knocking member 7 can knock on the rotary furnace 1 by passing through the via hole of the heat preservation housing 5. Therefore, the driving member 6 can be disposed outside the heat preservation housing 5, enabling the knocking member 7 to be driven by the driving member 6 to move away from the rotary furnace 1. The damage to the driving member 6 in a high temperature environment between the heat preservation housing 5 and the rotary furnace 1 is reduced, and it is beneficial to protection of the driving member 6.

The driving member 6 may be mounted directly above the knocking member 7 to drive the knocking member 7 to move upwards and away from the rotary furnace 1 against gravity. The knocking member 7 may also be driven by the driving member 6 to move through other components, enabling the relative position of the driving member 6 and the knocking member 7 to be flexible. For example, in some embodiments of the present disclosure, as illustrated in FIG. 4 to FIG. 6, the support 9 is provided with a guide wheel 81. The driving member 6 is connected to the knocking member 7 through a pull rope 82. The pull rope 82 is wound around the guide wheel 81. A part of the pull rope 82 located between the guide wheel 81 and the knocking member 7 extends in a vertical direction. A part of the pull rope 82 located between the guide wheel 81 and the driving member 6 extends in a driving direction of the driving member 6. The driving direction of the driving member 6 is inconsistent with a movement direction of the knocking member 7. Each of the driving direction of the driving member 6 and the movement direction of the knocking member 7 has directivity. For example, in some embodiments, as illustrated in FIG. 4, when the knocking member 7 is driven by the driving member 6 to move upwards, the driving direction is downward in the vertical direction, and the movement direction is upward in the vertical direction.

Through cooperation of the pull rope 82 and the guide wheel 81, the driving direction of the drive member 6 can be changed. In this way, the relative position of the driving member 6 and the knocking member 7 can be flexible, which can be adapted to different mounting space for mounting the driving member 6 and the knocking member 7. In this way, practicability and space compactness can be improved, while ensuring that the knocking member 7 is driven by the driving member 6 to move against the action of gravity. For example, in some embodiments, the driving member 6 is mounted at a right side, an upper right side, or the like of a gravity hammer 7.

In some embodiments, the knocking member 7 can be driven by the driving member 6 to move in the vertical direction through the pull rope 82 and the guide wheel 81. Moreover, the driving direction of the driving member 6 is inconsistent with the movement direction of the knocking member 7, which is conducive to the change of the driving direction, allowing the relative position of the driving member 6 and the knocking member 7 to be more flexible. A mounting height of the driving member 6 and a size of the support 9 can be reduced, and a mounting stability of the driving member 6 can be improved. Moreover, the mounting space of the knocking device 200 can be reduced and the space compactness of mounting can be improved.

For example, in some embodiments, the driving direction of the driving member 6 extends obliquely upwards from the guide wheel 81 to the driving member 6, to drive the knocking member 7 in an obliquely upward direction and to pull the knocking member 7 upwards through the guide wheel 81 and the pull rope 82, which is conducive to the reduction of the mounting height of the driving member 6 and a reduction in an occupied space of the knocking device 200. Alternatively, the driving direction of the driving member 6 extends from the guide wheel 81 to the driving member 6 in the horizontal direction, to drive the knocking member 7 in the horizontal direction and to pull the knocking member 7 upwards through the guide wheel 81 and the pull rope 82, allowing the mounting height of the driving member 6 to be lower and the space occupied by the knocking device 200 to be smaller.

Alternatively, the driving direction of the driving member 6 extends obliquely downwards from the guide wheel 81 to the driving member 6, to drive the knocking member 7 in an obliquely downward direction and to pull the knocking member 7 upwards through the guide wheel 81 and the pull rope 82, allowing the mounting height of the driving member 6 to be lower and the space occupied by the knocking device 200 to be smaller. Alternatively, the driving direction of the driving member 6 extends vertically downwards from the guide wheel 81 to the driving member 6, to drive the knocking member 7 downwards and to pull the knocking member 7 upwards through the guide wheel 81 and the pull rope 82, allowing the mounting height of the driving member 6 to be lower and the space occupied by the knocking device 200 to be smaller.

In some embodiments, at least two guide wheels 81 are provided, i.e., a first guide wheel and a second guide wheel. The first guide wheel and the second guide wheel are spaced apart from each other. A position of the second guide wheel in an axial direction of the rotary furnace 1 is adjustable. The pull rope 82 has an end connected to the driving member 6 and the other end connected to the knocking member 7. Moreover, the pull rope 82 is sequentially wound around the first guide wheel and the second guide wheel and is connected to the knocking member 7.

The driving direction of the first guide wheel and the second guide wheel can change flexibly. For example, in some embodiments, the first guide wheel enables the driving direction from a vertical direction between the first guide wheel and the driving member 6 to be changed into a horizontal direction between the second guide wheel and the first guide wheel, and the second guide wheel enables the driving direction from the horizontal direction between the first guide wheel and the second guide wheel to be changed into a vertical direction between the second guide wheel and the knocking member 7.

Moreover, the position of the second guide wheel in the axial direction of the rotary furnace 1 is adjustable, to adjust a position of the knocking member 7 in the axial direction of the rotary furnace 1, allowing the knocking member 7 to knock on different positions in the axial direction of the rotary furnace 1, with a wider knocking range. In some embodiments, the position of the second guide wheel in the axial direction of the rotary furnace 1 is adjustable. By adjusting the position of the second guide wheel, a position of an end of the pull rope 82 close to the knocking member 7 in the axial direction of the rotary furnace 1 is adjustable, and thus the position of the knocking member 7 in the axial direction of the rotary furnace 1 is adjusted, thereby adjusting the knocking range of the knocking member 7 on the rotary furnace 1 in the axial direction of the rotary furnace 1. Along the axial direction of the rotary furnace 1, more regions of the rotary furnace 1 can be knocked on, with a broader cleaning range and higher cleaning efficiency. Meanwhile, the rotary furnace 1 can be protected from being deformed or damaged by the knocking member 7 due to the repeated knocking on a fixed position of the rotary furnace 1 for a long period of time.

Moreover, through cooperation of the first guide wheel and the second guide wheel, a position of the pull rope 82 can be limited to reduce the offset of the pull rope 82 during a movement of the pull rope 82, thereby improving the stability of the movement of the knocking member 7 driven by the driving member 6 through the pull rope 82. For example, in some embodiments, the first guide wheel and the second guide wheel are spaced apart from each other in the axial direction of the rotary furnace 1, so that the part of the pull rope 82 located between the first guide wheel and the driving member 6 and the part of the pull rope 82 located between the second guide wheel and the knocking member 7 are not easily offset in the horizontal direction or even interfere with each other.

Certainly, three, four, or more guide wheels 81 may also be provided, so that the reversal of the driving direction is more flexible, and a position limit effect of the pull rope 82 is better.

In some embodiments, the support 9 has a guide hole 95 opposite to the via hole, and the knocking member 7 movably passes through the guide hole 95. The guide hole 95 can guide the movement of the knocking member 7 and limit a position of the knocking member 7, which reduces offset and shaking of the knocking member 7 during knocking, thereby improving reliability of the knocking operation and further improving cleaning stability of the rotary furnace 1.

In some embodiments, the support 9 has a plurality of guide holes 95 opposite to the via hole. The plurality of guide holes 95 are arranged at intervals in the axial direction of the rotary furnace 1, and the knocking member 7 selectively passes through one of the plurality of guide holes 95. In some embodiments, one via hole corresponds to the plurality of guide holes 95, and the knocking member 7 can be more conveniently adjusted to pass through any one of the plurality of guide holes 95 and to pass through the via hole to knock on the rotary furnace 1. In some embodiments, the plurality of via holes correspond to the plurality of guide holes 95, respectively, an opening area of the via hole and thus the heat loss in the heat preservation housing 5 can be reduced. A knocking position of the knocking member 7 can be adjusted by adjusting the position of the second guide wheel. Combined with the plurality of guide holes 95, the plurality of guide holes 95 can be respectively adapted to different positions of the knocking member 7, which is conducive to the guiding and position limit of the movement of the knocking member 7 under the premise of increasing the knocking range, thereby improving the operation stability of the knocking member 7.

In some embodiments of the present disclosure, as illustrated in FIG. 4, a length of the knocking member 7 is greater than a spacing between an axial outer end of the via hole and an outer circumferential surface of the rotary furnace 1, preventing the knocking member 7 to be completely located between the heat preservation housing 5 and the rotary furnace 1.

In this way, the knocking member 7 can be prevented from tilting between the heat preservation housing 5 and the rotary furnace 1 or even getting stuck between the heat preservation housing 5 and the rotary furnace 1, such that the knocking member 7 cannot leave the space between the rotary furnace 1 and the heat preservation housing 5 through the via hole. In this way, the knocking member 7 can easily move from the via hole in a direction away from the rotary furnace 1, which facilitates the repeated knocking of the knocking member 7, improving reliability of the knocking member 7 knocking on the rotary furnace 1.

In some embodiments of the present disclosure, as illustrated in FIG. 4, the knocking member 7 includes a knocking section 71 and a plurality of connection sections 72 sequentially connected to each other in a movement direction of the knocking member 7. An end portion of the knocking section 71 acts on the rotary furnace 1 by knocking. The connection section 72 is connected to the driving member 6. A cross-sectional area of the knocking section 71 perpendicular to the movement direction of the knocking member 7 is greater than a cross-sectional area of the connection section 72 perpendicular to the movement direction of the knocking member 7. Moreover, the cross-sectional area of the knocking section 71 perpendicular to the movement direction of the knocking member 7 is smaller than a cross-sectional area of the guide hole 95 perpendicular to a passing-through direction of the knocking member 95, and the cross-sectional area of the knocking section 71 perpendicular to the movement direction of the knocking member 7 is smaller than a cross-sectional area of the via hole perpendicular to the passing-through direction of the knocking member.

The movement direction of the knocking member 7 may refer to a lengthwise direction of the knocking member 7. The plurality of connection sections 72 may be one, two or more connection sections 72, and the connection section 72 connected to the driving member 6 may be any one of the plurality of connection sections 72. For example, in some embodiments, as illustrated in FIG. 4, the knocking member 7 includes one knocking section 71 and one connection section 72. The knocking section 71 is located at a lower side of the connection section 72 and close to the rotary furnace 1, and the connection section 72 is connected to the driving member 6 through the pull rope 82.

Each of the knocking section 71 and the connection section 72 can pass through the guide hole 96 and the via hole, and the knocking section 71 can knock on the rotary furnace 1, which are conducive to the improvement of the reliability of the knocking member 7 knocking on the rotary furnace 1. Moreover, on the premise that the knocking strength of the knocking member 7 satisfies the demand, the cross-sectional area of the knocking section 71 perpendicular to the movement direction of the knocking member 7 can be increased, to increase a knocking range of the knocking section 71 to the rotary furnace 1, which is conducive to cleaning of the rotary furnace 1 in a wider range. Moreover, by increasing the knocking range, stress concentration can be reduced, and the damage to the rotary furnace 1 is further reduced, which is beneficial to the protection of the rotary furnace 1.

In some embodiments, as illustrated in FIG. 4, the cross-sectional areas of the plurality of connection sections 72 perpendicular to the movement direction of the knocking member 7 decrease in a direction facing away from the knocking section 71, which is conducive to the reduction of a basic weight of the knocking member 7. In this way, a greater portion of the gravity of the knocking member 7 can be distributed on the knocking section 71, thereby increasing the knocking strength and knocking range of the knocking section 71.

In some embodiments of the present disclosure, as illustrated in FIG. 4, the knocking member 7 is provided with a weighted weight 73. A weight of the knocking member 7 can be increased by the weighted weight 73, and thus the knocking strength of the knocking member 7 is further increased, without increasing the knocking strength by increasing a volume of the knocking member 7. Thus, a utilization rate of a mounting space can be improved. Moreover, the number of weighted weights 73 can be increased or decreased at any time as required or the weighted weights 73 of different weights can be replaced as required, to adjust the knocking strength of the knocking member 7, without replacing the knocking members 7 of different weights, which is convenient to use.

The weighted weight 73 can be connected to the knocking member 7 through bolts, by riveting, welding, or the like. For example, in some embodiments, the weighted weight 73 is sleeved on the knocking member 7 and fixedly connected to the knocking member 7 through bolts.

In some embodiments, the cross-sectional area of the knocking section 71 perpendicular to the movement direction of the knocking member 7 and the cross-sectional area of the plurality of connection sections 72 perpendicular to the movement direction of the knocking member 7 decrease in the direction away from the rotary furnace 1, which is conducive to the reduction of the basic weight of the knocking member 7. Moreover, the knocking member 7 is provided with a weighted weight 73 at a side of the guide hole 95 facing away from the via hole. When the knocking strength is required to be increased, the number of weighted weights 73 can be increased to satisfy different knocking strength requirements, which is conducive to an increase in an adjustment range of the knocking strength.

In some embodiments, as illustrated in FIG. 4, a cross-sectional area of the weighted weight 73 perpendicular to the passing-through direction of the knocking member 95 is greater than a cross-sectional area of the guide hole 95 perpendicular to the passing-through direction of the knocking member 95. In this way, the knocking member 7 is unable to pass through the guide hole 95 downwards, thereby limiting the position of the movement of the knocking member 7. Thus, the knocking member 7 is prevented from being separated from the support 9 when the knocking member 7 moves downwards and passes through the guide hole 95 as a whole, thereby improving operation reliability of the knocking device 200.

In some embodiments, the weighted weight 73 is mounted and sleeved on the knocking member 7, and located at a side of the guide hole 95 facing away from the via hole. A distance between a bottom of the weighted weight 73 (i.e., an end portion of the weighted weight 73 close to the rotary furnace 1) and the end portion of the knocking section 71 (i.e., a knocking end of the knocking section 71 knocking on the rotary furnace 1) is L1, and a spacing between an axial outer end of the guide hole 95 and an outer circumferential surface of the rotary furnace 1 is L2, where L1≥L2. In this way, after the weighted weight 73 is mounted, the weighted weight 73 does not affect that the knocking member 7 passes through the via hole, such that the end portion of the knocking section 71 can knock on the rotary furnace 1 while guiding the knocking member 7.

In some embodiments of the present disclosure, as illustrated in FIG. 3 and FIG. 4, the support 9 includes a guide cylinder 94, and the guide cylinder 94 defines the guide hole 95. The movement of the knocking member 7 can be well guided and limited through the guide cylinder 94. The knocking member 7 can be guided and limited through the guide cylinder 94 and the guide hole 95 together, which is conducive to the improvement of guiding and position limiting effects on the knocking member 7, preventing the knocking member 7 from being offset in the vertical direction.

For example, in some embodiments, as illustrated in FIG. 3 and FIG. 4, the guide cylinder 94 extends in the length direction of the knocking member 7 (i.e., an up-down direction as illustrated in FIG. 3 and FIG. 4), and the knocking member 7 passes through the guide cylinder 94. The movement of the knocking member 7 can be guided and limited in the up-down direction through the guide cylinder 94, facilitating the movement of the knocking member 7 in the up-down direction and reducing the offset of the knocking member 7 with respect to the up-down direction, with god guide and position limit effects.

One or more guide cylinders 94 may be provided. Correspondingly, the number of guide holes 95 may be one or more. For example, in some embodiments, as illustrated in FIG. 3 and FIG. 4, the number of guide cylinders 94 is three, and the number of guide holes 95 is three. Moreover, the three guide cylinders 94 are in one-to-one correspondence with the three guide holes 95. The three guide cylinders 94 are arranged at intervals in the axial direction or arranged in contact with each other in the axial direction. The knocking member 7 selectively passes through one of the guide cylinder 94 and the corresponding guide hole 95. In this way, an action position where the knocking member 7 knocks on the rotary furnace 1 can be changed, and the knocking member 7 can be guided and limited. Thus, the knocking member 7 can be protected from partially deforming or even damaging the rotary furnace 1 due to the repeated knocking on a fixed position of the rotary furnace 1 for a long period of time.

In some embodiments of the present disclosure, as illustrated in FIG. 1 to FIG. 7, the driving member 6 has a driving end 61 connected to the pull rope 82. The driving end 61 is movable. One guide wheel 81 is provided. A part of the pull rope 82 located between the guide wheel 81 and the driving end 61 extends parallel to a movement direction of the driving end 61, and a part of the pull rope 82 located between the guide wheel 81 and the knocking member 7 extends parallel to a passing-through direction of the knocking member.

A driving direction of the driving end 61 can be changed through one guide wheel 81, allowing the relative position of the driving member 6 and the knocking member 7 to be more flexible, which is conducive to the reduction of the mounting height of the driving member 6 and saving of the occupied space of the knocking device 200. Moreover, the pull rope 82 is divided into two extending parts as described above through one guide wheel 81, which can reduce the number of direction-reversing of the pull rope 82 and shorten a movement time of the pull rope 82, thereby improving the knocking efficiency of the knocking member 7.

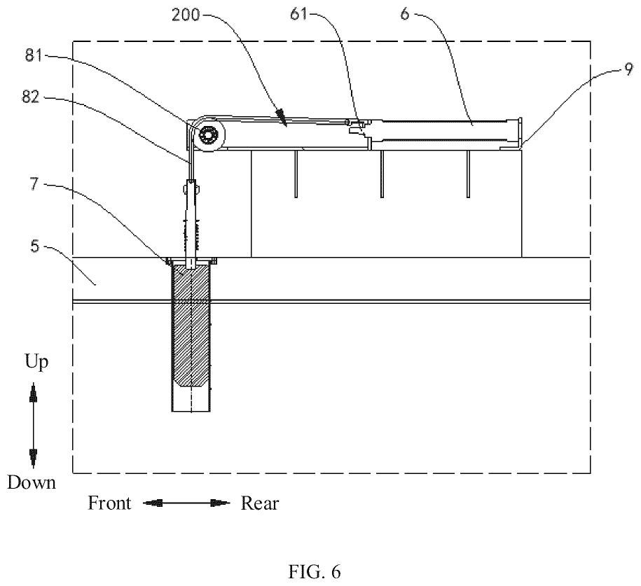

The driving end 61 is movable in the horizontal direction, in the vertical direction, or in other directions. For example, in some embodiments, as illustrated in FIG. 4, the driving end 61 is movable in the vertical direction, enabling the relative position of the driving member 6 and the knocking member 7 to be more flexible. For example, in some embodiments, as illustrated in FIG. 6, the driving end 61 is movable in the horizontal direction, which is beneficial to the improvement of the mounting stability of the driving member 6.

In some embodiments of the present disclosure, as illustrated in FIG. 4, the driving member 6 is an air cylinder. The air cylinder has a piston rod connected to the pull rope 82. By adjusting values of the air cylinder like an air intake volume and an air output volume of the air cylinder, a driving force and speed of the piston rod to the pull rope 82 can be adjusted, and the knocking strength and frequency of the knocking member 7 can be further adjusted, thereby facilitating operation. The air cylinder is easily damaged because of the influence of a high temperature. However, in the present disclosure, the driving member 6 can be disposed outside the heat preservation housing 5, i.e., the air cylinder is allowed to be disposed outside the high temperature environment between the heat preservation housing 5 and the rotary furnace 1, which can reduce a high temperature damage to the air cylinder, and is beneficial to protection for the air cylinder. In some embodiments, the piston rod is the driving end 61 of the driving member 6.

In some embodiments of the present disclosure, the rotary furnace 1 has a gasket provided at an outer circumferential surface of the rotary furnace 1. The gasket includes a plurality of cushion blocks arranged at a predetermined distance in a circumferential direction of the rotary furnace 1, and the knocking member 7 knocks the plurality of cushion blocks to act on the rotary furnace 1. The gasket between the knocking member 7 and the rotary furnace 1 can provide a buffer against a knocking force of the knocking member 7 knocking on the rotary furnace 1, so that the knocking member 7 knocks the cushion block and transmits the knocking force to the rotary furnace 1 through the cushion block, which lowers a direct impact force to the outer circumferential surface of the rotary furnace 1, and lowers a possibility of scratching or even deformation on the outer circumferential surface of the rotary furnace 1. Moreover, a damage of the knocking member 7 itself caused by direct knocking of the knocking member 7 on the rotary furnace 1 for a long time can be lowered, which is beneficial to protection of the rotary furnace 1 and the knocking member 7.

In addition, a contact area of the cushion block with the rotary furnace 1 is greater than a contact area of the knocking member 7 with the cushion block, and thus the knocking force of the knocking member 7 can be advantageously distributed on a larger region on the outer circumferential surface of the rotary furnace 1. In this way, a knocked area of the rotary furnace 1 can be increased, which is beneficial to cleaning of materials in a larger region on the inner wall of the rotary furnace 1, thereby improving the cleaning efficiency.

The gasket includes a plurality of cushion blocks arranged at a predetermined distance in the circumferential direction of the rotary furnace 1. The plurality of cushion blocks are arranged at predetermined distances, which is beneficial to adaptation to heat expansion and cold contraction of the rotary furnace 1 by the plurality of cushion blocks. Meanwhile, a distance between adjacent two cushion blocks is controlled, to keep sufficient space for heat expansion of the cushion block and the rotary furnace 1, but also allows sufficient margin to be not so large to reduce a possibility of the knocking member 7 knocking a gap between the two adjacent cushion blocks. Moreover, the plurality of cushion blocks are always attached to the outer circumferential surface of the rotary furnace 1.

For example, when high-temperature heat expansion of the rotary furnace 1 occurs, the gap between the two adjacent cushion blocks increases, avoiding the collision and extrusion of the two adjacent cushion blocks to separate the two adjacent cushion blocks w from the outer circumferential surface of the rotary furnace 1. Therefore, connection reliability between the gasket and the outer circumferential surface of the rotary furnace 1 is improved. Moreover, the knocking member 7 is less likely to knock the gap between the two adjacent cushion blocks due to the predetermined distance. In some embodiments, the knocking frequency of the knocking member 7 can also be adjusted through the driving member 6, in cooperation with controlling the rotational speed of the rotary furnace 1, the possibility of the knocking member 7 knocking the gap between the two adjacent cushion blocks can be advantageously reduced.

For example, when the rotary furnace 1 contracts in a cooling state, the gap between the two adjacent cushion blocks decreases, which can lower the possibility of the knocking member 7 knocking the gap between the two adjacent cushion blocks, thereby avoiding the collision and extrusion of the two adjacent cushion blocks due to the predetermined distance.

The predetermined distance can be determined according to actual parameters such as a material and strength of the rotary furnace 1. For example, the predetermined distance can range from 1 cm to 3 cm. For example, the predetermined distance is 1 cm, 2 cm, 3 cm, or etc.

In some embodiments, the cushion block is in an arc shape to adapt to a shape of the outer circumferential surface of the rotary furnace 1, which reduces a possibility of separation of the cushion block from the rotary furnace 1, thereby improving the connection reliability between the cushion block and the rotary furnace 1.

In some embodiments, in an axial direction of the washer, the gasket has a size ranging from 300 mm to 500 mm and a thickness ranging from 15 mm to 25 mm, which is beneficial to a reduction in a burden of the gasket on the rotary furnace 1 while increasing the knocking area, and facilitates normal rotation of the rotary furnace 1.

In some embodiments, the cushion blocks are made of the same material as the rotary furnace 1 to lower a possibility of corrosion of the rotary furnace 1 caused by the occurrence of reaction of the rotary furnace 1 with the cushion block because of an excessive temperature of the rotary furnace 1 during operation, which is beneficial to the protection of the rotary furnace 1. The cushion block can be mounted at the rotary furnace 1 by welding or other manners.

In some embodiments of the present disclosure, as illustrated in FIG. 1 and FIG. 2, a plurality of knocking devices 200 are provided. The plurality of knocking devices 200 are mounted at the heat preservation housing 5 at intervals in an axial direction of the rotary furnace 1.

One single knocking device 200 can knock on the rotary furnace 1 in more regions along the circumferential direction of the rotary furnace 1. Moreover, the plurality of knocking devices 200 arranged in the axial direction can knock on the rotary furnace 1 in more regions along the axial direction of the rotary furnace 1. Therefore, by means of the plurality of knocking devices 200, more regions on the rotary furnace 1 along the axial direction and the circumferential direction of the rotary furnace 1 can be knocked on, thereby increasing the knocking range and improving the cleaning efficiency. Moreover, each of the knocking devices 200 is independently controllable. By independently controlling the respective knocking devices 200, the plurality of knocking devices 200 can simultaneously or alternately knock on the rotary furnace 1, which is beneficial to control on the knocking frequency of the rotary furnace 1 in each region and the improvement of the cleaning efficiency.

In some embodiments, a plurality of temperature zones, which are arranged at intervals in the axial direction, can be divided by a heat preservation material in the heat preservation housing 5. At least one electric heater can be provided in each temperature zone, and each electric heater can be independently controlled by a programmable logic controller (PLC). In this way, heating temperatures of the respective temperature zones can be different, to satisfy requirements for different material sintering processes. For example, for a sintering process of the lithium-iron-phosphate positive electrode material, the plurality of temperature zones of the heat preservation housing 5 form a temperature rise section 101, a temperature holding section 102, and a cooling section 103. At least one knocking device 200 can be correspondingly provided in each of the temperature rise section 101 and the temperature holding section 102 with a high temperature (for example, with a temperature higher than a predetermined value). At least one knocking device 200 can also be correspondingly provided in each of the temperature rise section 101, the temperature holding section 102, and the cooling section 103. In this way, the knocking operations in different temperature zones can be realized, and the cleaning efficiency of the entire rotary furnace 1 is high. In some embodiments, one knocking device 200 can be provided correspondingly in each temperature zone of the temperature rise section 101 and the temperature holding section 102. Certainly, the number and arrangement position of the knocking devices 200 can be set according to actual requirements. For example, more than one knocking device 200 can be provided according to a temperature zone where actual material bonding is relatively more serious.

Based on the requirement for capacity improvement, the current rotary sintering furnaces tend to be large-scale. For example, rotary furnaces of some rotary sintering furnaces can reach more than 50 m. For a rotary furnace with a large size, the rotary furnace needs to be supported and driven at a middle part of the rotary furnace based on consideration of support stability and rotational torque. In some embodiments, as illustrated in FIG. 1, the temperature rise section 101, the temperature holding section 102, and the cooling section 103 of the heat preservation housing 5 are arranged at intervals. The rotary furnace 1 includes a furnace head 11, a first furnace section, a second furnace section, and a third furnace section. The first furnace section corresponds to the temperature rise section 101 of the heat preservation housing 5. The second furnace section corresponds to the temperature holding section 102 of the heat preservation housing 5. The third furnace section corresponds to the cooling section 103 of the heat preservation housing 5. A connection between the first furnace section and the second furnace section and a connection between the second furnace section and the third furnace section are each exposed outside the heat preservation housing 5. A support device is each provided in front of the temperature rise section 101, between the temperature rise section 101 and the temperature holding section 102, between the temperature holding section 102 and the cooling section 103, and behind the cooling section 103, to support the rotary furnace 1.

In some embodiments, the knocking device 200 further includes a pneumatic knocking hammer 400. The pneumatic knocking hammer 400 is disposed outside the furnace body assembly 100 and is disposed outside the rotary furnace 1 correspondingly between the furnace head 11 and the first furnace section, between the first furnace section and the second furnace section, and between the second furnace section and the third furnace section, to directly knock a part of the rotary furnace 1 exposed outside the heat preservation housing 5. Therefore, the pneumatic knocking hammer 400 is not in direct contact with the material in the rotary furnace 1, to avoid interference of the pneumatic knocking hammer 400 on material transportation and heating. Moreover, the knocking time, knocking frequency, and knocking strength are more intuitively controllable.

During the sintering of lithium iron phosphate material in the rotary sintering furnace, due to the characteristics of lithium iron phosphate material itself, the material is easy to be bonded on the inner wall of the rotary furnace or at the spiral blade in the rotary furnace. A temperature of the first furnace section gradually increases in a direction from the feed box to the second furnace section, and a temperature of the second furnace section is thermostatically high. Therefore, at a position of the first furnace section close to the second furnace section and in the second furnace section, after the material is bonded to the furnace wall and the spiral blade, it is more likely to cause over-sintered skinning of the material or reaction of the material with the furnace wall material of the rotary furnace due to the excessively high local sintering temperature of the material, which further leads to a problem of material loss or impurities carried in the product.

In the present disclosure, the pneumatic knocking hammer 400 is disposed between the furnace head 11 and the first furnace section and between the first furnace section and the second furnace section, which is beneficial to the knocking-off of materials bonded to the first furnace section and the second furnace section. The pneumatic knocking hammer 400 is disposed between the first furnace section and the second furnace section and between the second furnace section and the third furnace section, and cooperates with the knocking device 200 disposed in the second furnace section, which is beneficial to effective knocking on the material bonded in the second furnace section. Therefore, the pneumatic knocking hammer 400 is provided to facilitate the knocking at the vicinity of the rotary furnace 1 to which the over-sintered material is easily bonded, thereby effectively knocking off the bonded material.

In some embodiments, the pneumatic knocking hammer 400 can include an air source device and an air-hammer knocking device. The air source device is used for driving the air-hammer knocking device to knock on the rotary furnace 1. The air-hammer knocking device is pneumatically driven. The air-hammer knocking device is driven by a compressed air compressed by using an air compressor to knock on the rotary furnace 1. A knocking frequency, knocking strength, and the like of the air-hammer knocking device are controlled through the air source device. It is realized that a knocking process is adjustable and controllable, and different actual requirements are matched,

Therefore, by providing the knocking device 200 at a furnace section part and the pneumatic knocking hammer 400 between adjacent furnace sections, a part of the rotary furnace 1 at which the over-sintered material is easily bonded and accessories of the part can be knocked, further improving the cleaning efficiency.

In some embodiments of the present disclosure, the rotary furnace 1 has a furnace-chamber wall-surface polishing degree Ra smaller than or equal to 3 μm, so that a furnace-chamber wall surface of the rotary furnace 1 is relatively smooth, which it is beneficial to a reduction in a bonding rate of the material. For example, the furnace-chamber wall-surface polishing degree Ra of the rotary furnace 1 is 0.2 μm, 0.8 μm, 1.2 μm, 3 μm, and the like. Especially for the lithium-ion battery positive electrode material, the furnace-chamber wall-surface polishing degree Ra of the rotary furnace 1 is made smaller than or equal to 3 μm, which has a better effect of reducing a bonding rate of the lithium-ion battery positive electrode material during the sintering process.

In some embodiments of the present disclosure, the rotary furnace 1 is made of stainless steel or alloy, so that the rotary furnace 1 has good high-temperature resistance performance, which is beneficial to smooth progress of a high-temperature sintering operation, with good economy. For example, the rotary furnace 1 can be selected to be made of materials having resistance performance to a temperature ranging from 1,000° C. to 1,200° C. or resistance performance to higher temperatures, such as 304 stainless steel, 310S stainless steel, and Inconel 601/625 alloy, and materials having excellent stainless-steel corrosion resistance performance and good intergranular corrosion resistance performance, which can effectively improve introduction of magnetic substances to lithium iron phosphate during high-temperature sintering.

In some embodiments, the support 9 can be made of stainless steel or alloy, so that the support 9 has a high strength, which is beneficial to maintenance of mounting stability of the knocking device 200 mounted at the support 9. For example, the support 9 is made of steel.

In some embodiments, as illustrated in FIG. 3 to FIG. 5, the support 9 has a top frame 92, a vertical frame 91, and a bottom frame 93. The top frame 92 is connected to the bottom frame 93 through the vertical frame 91, and the support 9 is mounted at a top of the heat preservation housing 5 through the bottom frame 93. The guide wheel 81 is disposed at the top frame 92. The bottom frame 93 is provided with a guide cylinder 94. The guide cylinder 94 defines the guide hole 92, and the driving member 3 is mounted at the vertical frame 91. In this way, the support 9 is simple in structure and convenient to mount, with strong practicability. In some embodiments, the bottom frame 93 includes a bottom plate. The support 9 is mounted at the heat preservation housing 5 through the bottom plate. An inclined support plate is provided between the bottom frame 93 and the vertical frame 91 and between the top frame 92 and the vertical frame 91, which is conducive to the improvement of structural stability of the support 9.

In some embodiments, the support 9 is provided with a plurality of mounting positions. In some embodiments, the top support 92 is provided with a plurality of mounting positions. The plurality of mounting positions are arranged at intervals in the axial direction of the rotary furnace 1, and corresponding to positions of a plurality of guide holes 95 for mounting the knocking member 7. The second guide wheel is selectively mounted in one of the mounting positions to realize that the position of the second guide wheel in the axial direction of the rotary furnace 1 is adjustable. Further, after the pull rope 82 is wound around the second guide wheel for reversal, the knocking member 7 can selectively pass through one of the guide hole and the via hole correspondingly to knock on the rotary furnace 1, enabling a part of the pull rope between the second guide wheel and the knocking member 7 to be closer to or the same as an extending direction of the knocking member 7. In this way, a resistance that the pull rope 82 drives the knocking member 7 to move can be lowered. The driving member 6 can be mounted at the vertical frame 91 in the vertical direction, which makes the structure of the device simpler and more reasonable, thereby saving the occupied space.

In some embodiments, the top frame 92 has a mounting screw hole formed on each mounting position of the top frame 92. The support 9 also includes a plurality of corner frames and a fixing bolt. The second guide wheel is mounted in the mounting position through the corner frame and the fixing bolt. Certainly, the second guide wheel can also be mounted in the mounting position through other structures and other manners.

The support 9 can be integrated with the structure of the knocking device 200 and directly mounted above the heat preservation housing 5 through the bottom plate, without additionally providing a structure for mounting the support 9 outside the heat preservation housing 5, a structure connected between the support 9 and the heat preservation housing 5, and a fixed structure or a power driving structure, thereby facilitating the disassembly and assembly operations. Therefore, the support 9 can be mounted at a designated position of the rotary sintering furnace 1000 for knocking and cleaning.

In addition, the knocking device 200 has an independent driving device. For example, a knocking opportunity and the knocking frequency can be controlled by adjusting the driving member 6, i.e., adjusting the operation time and operation frequency of the air cylinder, to perform knocking flexibly and timely during the sintering process according to a sintering process and an actual bonding situation of a specific material. For example, knocking can be performed during the sintering process or after the sintering is completed, or the knocking can be performed during the sintering process and performed again after the sintering is completed. The knocking can be performed by setting a knocking time point. For example, the knocking is performed once every few minutes or every few seconds, or high-frequency knocking is performed at an early stage of the sintering process, and low-frequency knocking is performed at a later stage of the sintering process, and the like.

Other configurations and operations of the rotary sintering furnace 1000 according to embodiments of the present disclosure are known to those of ordinary skill in the art and will be omitted herein.

In the present disclosure, it should be noted that, unless otherwise clearly specified and limited, terms such as “install”, “connect”, “couple”, and the like should be understood in a broad sense. For example, it can be a fixed connection or a detachable connection or connection as one piece; a mechanical connection or an electrical connection; a direct connection or an indirect connection through an intermediate; or internal communication of two components. For those of ordinary skill in the art, the specific meaning of the above terms in the present disclosure should be understood according to specific circumstances.

In the description of this specification, descriptions with reference to the terms “embodiments”, “specific embodiments”, “examples”, etc., mean that specific features, structure, materials or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics can be combined in any one or more embodiments or examples in a suitable manner.

Although embodiments of the present disclosure have been illustrated and described, it is conceivable for those of ordinary skilled in the art that various changes, modifications, replacements, and variations can be made to these embodiments without departing from the principles and spirit of the present disclosure. The scope of the present disclosure shall be defined by the claims as appended and their equivalents.

What is claimed is:

1. A rotary sintering furnace, comprising:
a furnace body assembly comprising a rotary furnace and a heat preservation housing, the rotary furnace being rotatably disposed through the heat preservation housing, and the heat preservation housing having a via hole;
a knocking device disposed outside the heat preservation housing, the knocking device comprising a knocking member, the knocking member being configured to movably pass through the via hole and knock on the rotary furnace.

2. The rotary sintering furnace according to claim 1, wherein the knocking device further comprises:
a support mounted at the heat preservation housing; and
a driving member located outside the heat preservation housing and mounted at the support, the knocking member being connected to the driving member,
wherein the knocking member is adapted to reciprocate under the drive of the driving member and to pass through the via hole to knock on the rotary furnace, or
wherein the knocking member is adapted to reciprocate under the effect of gravity and the drive of the driving member and to pass through the via hole to knock on the rotary furnace.

3. The rotary sintering furnace according to claim 2, wherein:
the support is provided with a guide wheel;
the driving member is connected to the knocking member through a pull rope;
the pull rope is wound around the guide wheel;
a part of the pull rope located between the guide wheel and the knocking member extends in a vertical direction; and
a part of the pull rope located between the guide wheel and the driving member extends in a driving direction of the driving member, the driving direction of the driving member being inconsistent with a movement direction of the knocking member.

4. The rotary sintering furnace according to claim 3, wherein:
at least two guide wheels are provided, and the at least two guide wheels are respectively a first guide wheel and a second guide wheel that are spaced apart from each other, the second guide wheel being position-adjustable in an axial direction of the rotary furnace;
the pull rope has an end connected to the driving member and another end connected to the knocking member; and
the pull rope is sequentially wound around the first guide wheel and the second guide wheel to connect to the knocking member.

5. The rotary sintering furnace according to claim 4, wherein the support has a plurality of guide holes opposite to the via hole, the plurality of guide holes being arranged at intervals in the axial direction of the rotary furnace, and the knocking member selectively passing through one of the plurality of guide holes.

6. The rotary sintering furnace according to claim 5, wherein the support has a plurality of mounting positions arranged at intervals in the axial direction of the rotary furnace, the plurality of mounting positions positionally corresponding to the plurality of guide holes, and the second guide wheel being selectively mounted at one of the plurality of mounting positions.

7. The rotary sintering furnace according to claim 2, wherein the support has a guide hole opposite to the via hole, the knocking member movably passing through the guide hole.

8. The rotary sintering furnace according to claim 7, wherein the support comprises a top frame, a vertical frame, and a bottom frame connected to the top frame through the vertical frame, wherein:
the support is mounted at a top of the heat preservation housing through the bottom frame;
the guide wheel is disposed at the top frame;
the bottom frame is provided with a guide cylinder defining the guide hole; and
the driving member is mounted at the vertical frame.

9. The rotary sintering furnace according to claim 1, wherein a length of the knocking member is greater than a spacing between an axial outer end of the via hole and an outer circumferential surface of the rotary furnace.

10. The rotary sintering furnace according to claim 7, wherein the knocking member comprises a knocking section and a plurality of connection sections, the knocking section and the plurality of connection sections being sequentially connected to each other in a movement direction of the knocking member, wherein:
an end portion of the knocking section is configured to knock on the rotary furnace;
the plurality of connection sections are connected to the driving member;
a cross-sectional area of the knocking section perpendicular to the movement direction of the knocking member is greater than a cross-sectional area of each of the plurality of connection sections perpendicular to the movement direction of the knocking member;
the cross-sectional area of the knocking section perpendicular to the movement direction of the knocking member is smaller than a cross-sectional area of the guide hole perpendicular to a passing-through direction of the guide hole; and
the cross-sectional area of the knocking section perpendicular to the movement direction of the knocking member is smaller than a cross-sectional area of the via hole perpendicular to a passing-through direction of the via hole.

11. The rotary sintering furnace according to claim 7, wherein the knocking member is provided with a weighted weight.

12. The rotary sintering furnace according to claim 11, wherein:
the weighted weight is mounted and sleeved on the knocking member, and located at a side of the guide hole facing away from the via hole; and
a distance L1 between a bottom of the weighted weight and an end portion of the knocking section and a distance L2 between an axial outer end of the guide hole and an outer circumferential surface of the rotary furnace satisfy L1≥L2.

13. The rotary sintering furnace according to claim 3, wherein:
the driving member has a movable driving end connected to the pull rope;
one guide wheel is provided;
a part of the pull rope located between the guide wheel and the driving end extends parallel to a movement direction of the driving end; and
the part of the pull rope located between the guide wheel and the knocking member extends parallel to a passing-through direction of the via hole.

14. The rotary sintering furnace according to claim 1, wherein the rotary furnace has a gasket provided at an outer circumferential surface of the rotary furnace, the gasket comprising a plurality of cushion blocks arranged at a predetermined distance in a circumferential direction of the rotary furnace, and the knocking member acting on the rotary furnace by knocking the plurality of cushion blocks.

15. The rotary sintering furnace according to claim 14, wherein the plurality of cushion blocks are made of the same material as the rotary furnace.

16. The rotary sintering furnace according to claim 1, wherein a plurality of knocking devices are provided, the plurality of knocking devices being mounted at the heat preservation housing at intervals in an axial direction of the rotary furnace.

17. The rotary sintering furnace according to claim 1, wherein:
a furnace chamber wall of the rotary furnace has a polishing degree Ra smaller than or equal to 3 μm.

18. The rotary sintering furnace according to claim 1, wherein the rotary furnace is made of stainless steel or alloy.

19. The rotary sintering furnace according to claim 1, wherein the rotary sintering furnace is for use in the preparation of a new energy material by performing dynamic sintering on a raw material, wherein the new energy material comprises a lithium-ion battery positive electrode material, the lithium-ion battery positive electrode material comprising lithium iron phosphate, lithium cobalt oxide, or lithium nickel cobalt manganate.
